(19) United States
(12) Patent Application Publication
(10) Pub. No.: US 2009/0133399 A1
(43) Pub. Date: May 28, 2009

(54) Turbocharger system implementing real time speed limiting

(75) Inventors: Joshua David Keyes, East Peoria, IL (US); Jennifer Lynn Wilson, East Peoria, IL (US); James Harris Mutti, Metamora, IL (US); Stephen Michael Wiley, East Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/987,070

(22) Filed: Nov. 27, 2007

(51) Int. Cl. F02D 23/00

(52) U.S. Cl. 60/602

(57) ABSTRACT

A turbocharger system for use with an engine having a braking mode of operation is disclosed. The turbocharger system may have a turbocharger with variable geometry, and a sensor situated to generate a signal indicative of a turbocharger speed. The turbocharger system may also have a controller in communication with the turbocharger and the sensor. The controller may be configured to vary the geometry of the turbocharger during the engine's braking mode of operation to increase a backpressure of the engine. The controller may also be configured to vary the geometry of the turbocharger to reduce the backpressure when the signal indicates a speed of the turbocharger within an amount of a desired speed.

### TECHNICAL FIELD

The present disclosure relates generally to a turbocharger system and, more particularly, to a turbocharger system that implements real time speed limiting.

### BACKGROUND

Machines, including on and off-highway haul and vocational trucks, wheel loaders, motor graders, and other types of heavy equipment generally include a multi-speed, bidirectional, mechanical transmission drivingly coupled to an engine. When the engine's output and transmission's input shafts are mechanically coupled, the engine can be used to slow the machine's travel. For example, power can be transferred from the wheels of the machine in reverse direction through the transmission to drive the mechanically coupled engine. A natural resistance of the engine then dissipates some of the transferred power, thereby slowing the machine. Additional power can be dissipated through the use of compression braking that increases the resistance of the engine.

To boost braking even more, a variable geometry turbocharger (VGT) can be employed. A VGT is a turbocharger having geometry (e.g., vanes, nozzle ring, housing walls, etc.) that can be adjusted to increase a backpressure within the engine. The increased backpressure, when combined with compression braking, works against motion of the engine's pistons, thereby slowing the engine and machine travel even more.

Although effective at increasing a machine's braking ability, it may be possible to damage the turbocharger during compression braking. Specifically, as the geometry of the turbocharger is varied to increase backpressure, a speed of the turbocharger increases proportional to the backpressure. In some situations, it may be possible for the turbocharger's speed to increase beyond a recommended maximum speed limit. In these situations, a component life of the turbocharger may be compromised.

One method of improving the life of a turbocharger during braking is described in U.S. Patent Publication No. 2004/0016232 (the '232 publication) by Warner et al. published on Jan. 29, 2004. Specifically, the '232 publication describes a method of controlling an internal combustion engine when the engine is operating in a braking mode to dissipate power. The method includes opening an exhaust valve early during a compression stroke to dissipate power. The method further includes comparing a desired mass air flow rate with an actual mass air flow rate, and determining a braking turbocharger geometry based on the comparison. The method also includes receiving an actual turbocharger speed and a maximum turbocharger speed. The actual turbocharger speed is compared with the maximum turbocharger speed to define a limit turbocharger geometry. The limit turbocharger geometry is then compared to the braking turbocharger geometry and the actual turbocharger geometry is varied based on this comparison to increase backpressure available for braking. That is, closed loop control causes the actual turbocharger geometry to track the braking turbocharger geometry under normal conditions. However, if the braking turbocharger geometry is greater than the limit turbocharger geometry, the actual turbocharger geometry is instead controlled to track the limit turbocharger geometry. In this manner, it may be assured that the turbo does not overspeed and damage the turbocharger.

Although the method of the '232 publication may help minimize turbocharger overspeed during braking, it may be complex, unresponsive, and limited. In particular, the method of the '232 publication requires many different comparisons and geometry determinations. Each of these comparisons and determinations increases the complexity of the system and may slow the system down. And, because actual turbocharger geometry is based only indirectly on variables related to turbocharger speed (i.e., based on a comparison involving limit geometry, which is based further on a comparison of a received turbocharger speed and a received maximum turbocharger speed), the ability to accurately maintain turbocharger speeds below the maximum acceptable speed may be poor.

The disclosed turbocharger system is directed to overcoming one or more of the problems set forth above.

### SUMMARY

In one aspect, the present disclosure is directed to a turbocharger system for use with an engine having a braking mode of operation. The turbocharger system may include a turbocharger having variable geometry, and a sensor situated to generate a signal indicative of a turbocharger speed. The turbocharger system may also include a controller in communication with the turbocharger and the sensor. The controller may be configured to vary geometry of the turbocharger during the engine's braking mode of operation to increase a backpressure of the engine. The controller may also be configured to vary geometry of the turbocharger to reduce the backpressure when the signal indicates a speed of the turbocharger within an amount of a desired speed.

In yet another aspect, the present disclosure is directed to a method of decelerating an engine. The method may include varying geometry of a turbocharger to increase an amount of energy dissipated through motion of the engine. The method may further include sensing a speed of the turbocharger, and varying geometry of the turbocharger to reduce the amount of energy dissipated when the speed of the turbocharger is within an amount of a desired speed.

### BRIEF DESCRIPTION OF THE DRAWING

FIG. 1 is a diagrammatic illustration of an exemplary disclosed power system.

### DETAILED DESCRIPTION

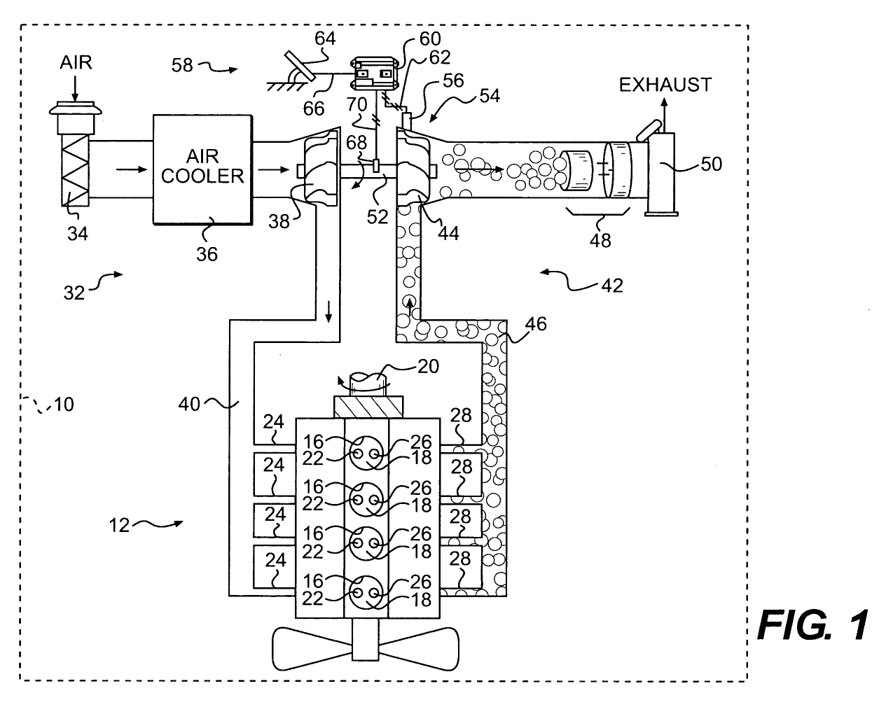

FIG. 1 illustrates an exemplary machine 10. Machine 10 may embody a mobile or stationary machine that performs some type of operation associated with an industry such as mining, construction, farming, transportation, or any other industry known in the art. For example, machine 10 may be an earth moving machine such as an off-highway haul truck, a wheel loader, a motor grader, or any other suitable earth moving machine. Machine 10 may alternatively embody an on-highway vocational truck, a passenger vehicle, or any other operation-performing machine. Machine 10 may include, among other things, a power system 12. In one embodiment, power system 12 may be connected to a traction device (not shown) so as to propel machine 10.

Power system 12 is depicted in FIG. 1 and described herein as a diesel-fueled, internal combustion engine. However, it is contemplated that power system 12 may embody any other type of internal combustion engine, such as, for example, a gasoline or gaseous fuel-powered engine. Power system 12 may include an engine block 14 at least partially defining a plurality of cylinders 16, and a plurality of piston assemblies 18 disposed within cylinders 16. It is contemplated that power system 12 may include any number of cylinders 16 and that cylinders 16 may be disposed in an “in-line” configuration, a “V” configuration, or any other conventional configuration.

Each piston assembly 18 may be configured to reciprocate between a bottom-dead-center (BDC) position, or lower-most position within cylinder 16, and a top-dead-center (TDC) position, or upper-most position within cylinder 16. In particular, piston assembly 18 may be pivotally coupled to a crankshaft 20 by way of a connecting rod (not shown). Crankshaft 20 of power system 12 may be rotatably disposed within engine block 14, and each piston assembly 18 coupled to crankshaft 20 such that a sliding motion of each piston assembly 18 within each cylinder 16 results in a rotation of crankshaft 20. Similarly, a rotation of crankshaft 20 may result in a sliding motion of piston assemblies 18. As crankshaft 20 rotates through about 180 degrees, piston assembly 18 may move through one full stroke between BDC and TDC. In one embodiment, power system 12 may be a four stroke (e.g., four cycle) engine, wherein a complete cycle includes an intake stroke (TDC to BDC), a compression stroke (BDC to TDC), a power stroke (TDC to BDC), and an exhaust stroke (BDC to TDC). It is also contemplated that power system 12 may alternatively embody a two stroke (e.g., two cycle) engine, wherein a complete cycle includes a compression/exhaust stroke (BDC to TDC) and a power/exhaust/intake stroke (TDC to BDC).

An intake valve 22 may be associated with each cylinder 16 to selectively restrict fluid flow through a respective intake port 24. Each intake valve 22 may be actuated to move or “lift” to thereby open the respective intake port 24. In a cylinder 16 having a pair of intake ports 24 and a pair of intake valves 22, the pair of intake valves 22 may be actuated by a single valve actuator (not shown) or by a pair of valve actuators (not shown). Of the four piston strokes described above, each intake valve 22 may open during a portion of the intake stroke to allow air or an air and fuel mixture to enter each respective cylinder 16 during normal operation.

An exhaust valve 26 may also be associated with each cylinder 16, and configured to selectively block a respective exhaust port 28. Each exhaust valve 26 may be actuated to move or “lift” to thereby open the respective exhaust port 28. In a cylinder 16 having a pair of exhaust ports 28 and a pair of exhaust valves 26, the pair of exhaust valves 26 may be actuated by a single valve actuator (not shown) or by a pair of valve actuators (not shown). Of the four piston strokes described above, each exhaust valve 26 may open during a portion of the exhaust stroke to allow exhaust to be pushed from each respective cylinder 16 by the motion of piston assemblies 18. During a compression braking mode of operation, exhaust valves 26 associated with one or more of cylinders 16 may be selectively opened during a portion of the compression stroke, an the pressure within exhaust port 28 may be selectively elevated such that the high pressure exhaust communicated with cylinders 16 via exhaust valves 26 acts against the motion of piston assemblies 18 and slows them down.

Each of intake and exhaust valves 22, 26 may be operated in any conventional manner to move from the closed or flow blocking position to an open or flow passing position in a cyclical manner. For example, intake and exhaust valves 22, 26 may be lifted by way of a cam (not shown) that is rotatingly driven by crankshaft 20, by way of a hydraulic actuator (not shown), by way of an electronic actuator (not shown), or in any other manner. During normal operation of power system 12, intake and exhaust valves 22, 26 may be lifted in a predefined cycle related to the motion of piston assemblies 18. It is contemplated, however, that a variable valve actuator (not shown) may be associated with one or more of intake and/or exhaust valves 22, 26 to selectively interrupt the cyclical motion thereof during alternative modes of operation. In particular, one or more of intake and/or exhaust valves 22, 26 may be selectively opened, held open, closed, or held closed to implement the compression braking mode of operation, an exhaust gas recirculation mode of operation, a low-NOx mode of operation, an homogenous combustion compression ignition (HCCI) mode of operation, or any other known mode of operation, if desired.

An air induction system 32 may be associated with power system 12 and include components that condition and introduce compressed air into cylinders 16 by way of intake ports 24 and intake valves 22. For example, air induction system 32 may include an air filter 34, an air cooler 36 located down stream of air filter 34, and a compressor 38 connected to draw inlet air through filter 34 and cooler 36. It is contemplated that air induction system 32 may include different or additional components than described above such as, for example, inlet bypass components, a throttle valve, and other known components.

Air filter 34 may be configured to remove or trap debris from air flowing into power system 12. For example, air filter 34 may include a full-flow filter, a self-cleaning filter, a centrifuge filter, an electro-static precipitator, or any other type of air filtering device known in the art. It is contemplated that more than one air filter 34 may be included within air induction system 32 and disposed in a series or parallel arrangement, if desired. Air filter 34 may be connected to inlet ports 24 via a fluid passageway 40.

Air cooler 36 may embody an air-to-air heat exchanger or an air-to-liquid heat exchanger disposed within fluid passageway 40 and configured to facilitate the transfer of heat to or from the air directed into cylinders 16. For example, air cooler 36 may include a tube and shell type heat exchanger, a plate type heat exchanger, a tube and fin type heat exchanger, or any other type of heat exchanger known in the art. By cooling the air directed into cylinders 16, a greater amount of air may be drawn into power system 12 during any one combustion cycle. The flow of air directed through air cooler 36 may be regulated by an induction valve (not shown) such that a desired flow rate, pressure, and/or temperature at the inlet of power system 12 may be achieved. Although illustrated as being located upstream of compressor 38, it is contemplated that air cooler 36 may alternatively or additionally be located downstream of air cooler 36, if desired.

Compressor 38 may also be disposed within fluid passageway 40 and located downstream of air filter 34 to compress the air flowing into power system 12. Compressor 38 may embody a fixed geometry type compressor, a variable geometry type compressor, or any other type of compressor known in the art. It is contemplated that more than one compressor 38 may be included within air induction system 32 and disposed in parallel or in series relationship, if desired.

An exhaust system 42 may also be associated with power system 12, and include components that condition and direct exhaust from cylinders 16 by way of exhaust ports 28 and exhaust valves 26. For example, exhaust system 42 may include a turbine 44 disposed within a passageway 46 and driven by the exiting exhaust, one or more exhaust treatment devices 48 fluidly connected downstream of turbine 44, and an exhaust outlet 50 configured to direct treated exhaust from passageway 46 to the atmosphere. It is contemplated that exhaust system 42 may include different or additional components than described above such as, for example, exhaust bypass components, an exhaust gas recirculation circuit, an exhaust brake, and other known components.

Turbine 44 may also be disposed within fluid passageway 46 and located to receive exhaust leaving power system 12 via exhaust ports 28. Turbine 44 may be connected to one or more compressors 38 of air induction system 32 by way of a common shaft 52 to form a turbocharger 54. As the hot exhaust gases exiting power system 12 move through passageway 46 to turbine 44 and expand against vanes (not shown) thereof, turbine 44 may rotate and drive the connected compressor 38 to pressurize inlet air. It is contemplated that more than one turbine 44 may be included within exhaust system 42 and disposed in parallel or in series relationship, if desired.

Turbine 44 may embody a variable geometry turbine (VGT). VGTs are a variety of turbochargers having geometry adjustable to attain different aspect ratios such that adequate boost pressure may be supplied to cylinders 16 under a range of operational conditions. In one embodiment, turbine 44 may include vanes movable by an actuator 56. As these vanes move, a flow area between the vanes may change, thereby changing the aspect ratio of turbocharger 54. In another embodiment, turbine 44 may have nozzle ring adjustable by actuator 56. During operation of turbocharger 54, the orientation of the nozzle ring may be adjusted to vary a flow area through a nozzle portion (not shown) of turbine 44. It is contemplated that other types of VGTs may also be utilized in conjunction with the disclosed power system, if desired.

As the flow area of turbine 44 changes, the performance of turbocharger 54 may also change. For example, as the flow area decreases, the pressure within passageway 46 upstream of turbine 44 (i.e., the backpressure of power system 12) may proportionally increase. This increased pressure may work against the vanes of turbine 44 to rotate turbine 44, shaft 52, and connected compressor 38 at a faster rate, resulting in an increased boost pressure within passageway 40. In contrast, as the flow area increases, the pressure within passageway 46 may proportionally decrease, and turbine 44, shaft 52, and compressor 38 may slow down to compress less air.

A control system 58 may be associated with power system 12 to regulate the operation of turbocharger 54 during a compression braking mode of operation. In particular, control system 58 may include a controller 60 in communication with actuator 56 by way of a communication line 62. In response to a change in braking demand, controller 60 may regulate actuator 56 to vary the flow area of turbine 44. As mentioned above, a reduction in flow area may result in an increase in backpressure within passageway 46 and vice versa. And, an increased backpressure, which may be fluidly communicated with piston assemblies 18 by way of exhaust ports 28 and exhaust valves 26 during conventional compression braking, may increase the resistance to piston motion and work to slow power system 12. In contrast, a decreased backpressure may reduce the resistance to piston motion, thereby reducing braking of power system 12.

The demand for braking or a demand for an increase in braking may be received by way of an operator input device 64, which may be in communication with controller 60 via a communication line 66. As an operator depresses input device 64, for example a brake pedal, the demand for braking may be generated. As the operator depresses input device 64 even more, a demand for increased braking may be generated. Similarly, as the operator depresses input device 64 less, the demand for braking may be reduced. It is contemplated that the demand for braking or increased braking may alternatively or additional be automatically generated based one or more operational parameters of machine 10 (e.g., a travel speed, a gear ratio, an incline, etc.), if desired.

It may be possible, in some situations, for the speed of turbocharger 54 to become excessive when the geometry of turbine 44 is adjusted to slow power system 12 (by increasing the backpressure thereof). That is, the speed of turbine 44, shaft 52, and/or compressor 38, if unaccounted for, could increase to a level that compromises the integrity of turbocharger 54. To help minimize the likelihood of turbocharger damage, controller 60 may monitor turbocharger speed and adjust the geometry of turbine 44 accordingly. For this reason, control system 58 may include a turbo speed sensor 68 in communication with controller 60 via a communication line 70. In this configuration, controller 60 may regulate actuator 56 in closed-loop manner to reduce the backpressure within passageway 46 when an actual speed of turbocharger 54, as measured by sensor 68, is within an amount of a limit speed. That is, as the actual speed of turbocharger 54 nears or exceeds a maximum acceptable speed limit, actuator 56 may be energized to adjust the geometry of turbine 44 (i.e., increase the flow area thereof) until the actual speed is reduced acceptably (i.e., until the actual speed is again about equal to or less than the maximum acceptable speed limit).

Controller 60 may embody a single microprocessor or multiple microprocessors that include a means for controlling an operation of actuator 56. Numerous commercially available microprocessors can be configured to perform the functions of controller 60. It should be appreciated that controller 60 could readily embody a general machine microprocessor capable of controlling numerous machine functions and modes of operation. Various other known circuits may be associated with controller 60, including power supply circuitry, signal-conditioning circuitry, solenoid driver circuitry, communication circuitry, and other appropriate circuitry.

### INDUSTRIAL APPLICABILITY

The disclosed turbocharger system may be applicable to any power system where turbo-assisted compression braking is desired, without compromise of the turbocharger's component life. The disclosed turbocharger system may selectively adjust the geometry of a variable geometry turbine (VGT) to increase a backpressure of the power system. This increased backpressure, when combined with conventional compression braking, may work against motion of the power system's piston to slow the power system. To minimize the likelihood of overspeed damage, operation of the turbine may be monitored and selectively speed regulated in closed loop fashion.

Several advantages may be associated with the turbocharger system of the present disclosure. In particular, the disclosed turbocharger system may be simple, responsive, and accurate. The disclosed system may be simple, because it relies on a minimal number of comparisons and determinations. That is, the disclosed turbocharging system may directly measure turbine speed and adjust turbine geometry (i.e., flow area) in real time when the turbine speed nears or exceeds a maximum acceptable speed limit. Because of the simplicity of the system, the responsiveness thereof may be great. And, because the system operates in closed loop fashion based directly on a measured turbine speed, the accuracy of maintaining an actual turbine speed at or below the maximum acceptable speed limit may be high.

It will be apparent to those skilled in the art that various modifications and variations can be made to the turbocharger system of the present disclosure. Other embodiments of the turbocharger system will be apparent to those skilled in the art from consideration of the specification and practice of the retarding system disclosed herein. It is intended that the specification and examples be considered as exemplary only, with a true scope of the disclosure being indicated by the following claims and their equivalents.

What is claimed is:

1. A turbocharger system for use with an engine having a braking mode of operation, the turbocharger system comprising:
a turbocharger having variable geometry;
a sensor situated to generate a signal indicative of a turbocharger speed; and
a controller in communication with the turbocharger and the sensor, the controller being configured to:
vary geometry of the turbocharger during the engine's braking mode of operation to increase a backpressure of the engine; and
vary geometry of the turbocharger to reduce the backpressure when the signal indicates a speed of the turbocharger within an amount of a desired speed.

2. The turbocharger system of claim 1, wherein the controller is configured to vary the geometry of the turbocharger to reduce the backpressure when the signal indicates a speed of the turbocharger exceeding the desired speed.

3. The turbocharger system of claim 2, wherein the desired speed is related to a maximum acceptable speed of the turbocharger.

4. The turbocharger system of claim 1, wherein the turbocharger geometry is varied in closed loop fashion based on the signal.

5. The turbocharger system of claim 1, wherein the turbocharger includes one of a movable vane and a movable nozzle ring.

6. The turbocharger system of claim 1, wherein the controller is configured to:
receive an input indicating a demand for increased braking; and
vary the geometry of the turbocharger to increase the backpressure based on the input until the signal indicates the speed of the turbocharger is about equal to the desired speed.

7. The turbocharger system of claim 1, wherein:
the turbocharger includes:
a compressor wheel;
a turbine wheel; and
a shaft connecting the turbine wheel to the compressor wheel; and
the sensor is associated with one of the compressor wheel, the turbine wheel, and the shaft to determine a rotational speed thereof.

8. A method of decelerating an engine, comprising:
varying the geometry of a turbocharger to increase an amount of energy dissipated through motion of the engine;
sensing a speed of the turbocharger; and
varying geometry of the turbocharger to reduce the amount of energy dissipated when the speed of the turbocharger is within an amount of a desired speed.

9. The method of claim 8, wherein varying the geometry of the turbocharger to reduce the amount of energy dissipated includes varying the geometry of the turbocharger to reduce a backpressure of the engine when the speed of the turbocharger exceeds the desired speed.

10. The method of claim 9, wherein the desired speed is related to a maximum acceptable speed of the turbocharger.

11. The method of claim 8, wherein the turbocharger geometry is varied in closed loop fashion based on the speed.

12. The method of claim 8, wherein varying the geometry includes moving one of a vane and a nozzle ring.

13. The method of claim 8, further including:
receiving an input indicating a demand for increased braking; and
varying the geometry of the turbocharger to increase the backpressure based on the input until the speed of the turbocharger is about equal to the desired speed.

14. The method of claim 8, wherein sensing includes sensing a rotational speed of at least one of a compressor wheel, a turbine wheel, and a shaft connecting the compressor wheel to the turbine wheel.

15. An engine system, comprising:
a engine block at least partially defining a cylinder;
an engine valve movable between a flow passing position and a flow restricting position;
a turbocharger in fluid communication with the cylinder via the engine valve, the turbocharger having variable geometry;
a sensor situated to generate a signal indicative of a turbocharger speed; and
a controller in communication with the turbocharger and the sensor, the controller being configured to:
vary geometry of the turbocharger during an engine braking mode of operation to increase a backpressure within the cylinder; and
vary geometry of the turbocharger to reduce the backpressure when the signal indicates a speed of the turbocharger within an amount of a desired speed.

16. The engine system of claim 15, wherein the controller is configured to vary the geometry of the turbocharger to reduce the backpressure when the signal indicates a speed of the turbocharger exceeding the desired speed.

17. The engine system of claim 16, wherein the desired speed is related to a maximum acceptable speed of the turbocharger.

18. The engine system of claim 15, wherein the turbocharger geometry is varied in closed loop fashion based on the signal.

19. The engine system of claim 15, wherein the turbocharger includes one of a movable vane and a movable nozzle ring.

20. The engine system of claim 15, wherein the controller is configured to:
receive an input indicating a demand for increased braking; and
vary the geometry of the turbocharger to increase the backpressure based on the input until the signal indicates the speed of the turbocharger is about equal to the desired speed.
